(19) United States
(12) Patent Application Publication
(10) Pub. No.: US 2017/0297936 A1
(43) Pub. Date: Oct. 19, 2017

(54) Surface Water Mitigation Structure

(71) Applicant: Sports Care Products, Inc., Cleveland, OH (US)

(72) Inventors: David Komocki, Novelty, OH (US); Peter C. Beeson, Jamestown, NY (US)

(21) Appl. No.: 15/468,399

(22) Filed: Mar. 24, 2017

Related U.S. Application Data
(60) Provisional application No. 62/321,779, filed on Apr. 13, 2016.

(51) Int. Cl. C02F 3/10; C02F 3/04; C02F 101/32; C02F 103/00

(52) U.S. Cl. CPC C02F 3/104; C02F 3/04; C02F 2101/32; C02F 2209/40; C02F 2103/001

(57) ABSTRACT

A surface water mitigation structure suitable for use in the storage and treatment of contaminated surface water runoff. The runoff is processed through a multi-layered filtration and treatment system wherein the first layer is a permeable composite capstone that can support substantial loads yet is pervious enough to allow runoff to pass through it and into a porous storage medium second layer that includes one or more remediating agents, and wherein the effluent from the surface water mitigation structure can be discharged to the ground, the surface, and/or a drainage system reduced or free of contaminants.

The present invention claims priority on U.S. Provisional Patent Application Ser. No. 62/321,779 filed Apr. 13, 2016, which is incorporated herein by reference.

The present invention is directed to a multi-layered surface/subsurface structure suitable for use as a water treatment and/or filtration system. The invention finds particular application in conjunction with storage and treatment of contaminated surface water and will be described with particular reference thereto. However, it is to be appreciated that the present invention is also amenable to other applications.

### BACKGROUND OF THE INVENTION

Contaminated water is a worldwide problem. Surface water runoff (hereafter referred as “runoff”) from roadways, parking lots, factories, and fertilized fields are often contaminated with undesirable compounds that are hazardous to both the environment and to human health. For example, runoff containing hydrocarbons can adversely affect the central nervous system or affect the blood, immune system, lungs, skin, and eyes. Also, water containing high nutrient load can contribute to the contamination and production of harmful algae blooms that affect lake water, river water, sewer water, reservoir facilities, etc.

Generally, such contaminants (e.g., hydrocarbons, etc.) are attributed to the use of cars, trucks, trains, etc. on the surface of roadways, parking lots, etc. and can infiltrate into the ground, thereby contaminating reservoirs and the underlying groundwater. The contamination is typically the result of waste leaking or leaching onto roadways, sidewalks, the ground, etc. that is then flushed off the impermeable roadways and into the ground after a period of precipitation.

It would be desirable to provide a surface water mitigation structure and/or topping that can be used to treat such contaminated surface water runoff prior to it entering aquifers and reservoirs.

### SUMMARY OF THE INVENTION

The present invention is directed to a surface water mitigation structure and/or topping that can be used as a water treatment and/or filtration system which is durable enough to be used in outdoor applications (e.g., roadways, parking lots, sidewalks, cart paths, bicycle paths, urban tree surrounds, horse stalls, drainage basins, etc.), and which surface water mitigation structure and/or topping has a multi-layered structure that includes remediating agents used to at least partially treat contaminants, and which can be used to treat contaminated water effectively.

According to one non-limiting aspect of the present invention, the surface water mitigation structure can comprise at least two layers: 1) a permeable composite capstone layer that can support substantial loads yet can be pervious enough to allow top water runoff to pass through the layer; and 2) a porous storage medium layer that can absorb and/or hold water that has passed through the permeable composite capstone layer. The porous storage medium layer is designed to at least contain and/or be inoculated with remediating agents (e.g., chemical, physical, and/or biological remediating agents) that are designed to break down contaminants in the runoff that has passed through the permeable composite capstone layer. This could be done at the time of installation or post-added. The porous storage medium layer is also designed to retain and/or absorb the runoff for a period of time to allow the remediating agents to break down the contaminants before the runoff enters the surrounding environment.

The surface water mitigation structure of the present invention is capable of removing contaminants and/or pollutants (e.g., water that includes human and/or animal waste, pesticides, hydrocarbons [e.g., gasoline, oil, solvents, wax, lubricants, etc.), organic waste, inorganic waste, metals, etc.) from runoff (e.g., storm water runoff, waste water runoff, water runoff from irrigation, precipitation, broken water lines, natural disasters, etc.) by subjecting the water through a multi-layered filtration and treatment system. Although the present invention is described as being a multi-layered system, it can be appreciated that the present invention can be designed to be a single-layered system; however, this is not required.

The first layer of the system of the present invention is the permeable composite capstone layer that can support substantial loads yet be pervious enough to allow surface water and other liquid runoff to pass through it. The flow path of the water and other liquids through the permeable composite capstone layer can be effected by its structure. The water and other liquid from the permeable composite capstone layer then flows into the porous storage medium layer where it is treated under aerobic conditions. The treated water and other liquid from the surface water mitigation structure can be discharged to the ground, the surface, and/or a drainage system.

Generally, the surface water mitigation structure is constructed such that the force of gravity causes the runoff to pass through the permeable composite capstone layer and into the porous storage medium layer with remediating agents. As such, the surface water mitigation structure is capable of collecting water, storing water, treating contaminants with chemical, physical and/or biological remediating agents, and then releasing the treated runoff; however, this is not required. As such, contaminated runoff can be treated such that any untreated contaminants flowing into storm sewers or directly into wetlands can be reduced and/or eliminated.

According to one non-limiting aspect of the invention, the permeable composite capstone layer can be a composite; however, this is not required. The permeable composite capstone layer is designed to support substantial loads while remaining permeable enough to allow top runoff to pass through the permeable composite capstone layer. The permeable composite capstone layer can be formed from a variety of natural materials (e.g., limestone, shale, slate, sandstone, quartz, feldspar, dolomite, obsidian, mica, diorite, flint, granite, etc.) and/or one or more man-made materials (e.g., glass, rubber, recycled concrete, recycled asphalt, expanded shale, expanded slate, recycled plastic, etc.). In other and/or alternative non-limiting embodiments, the one or more materials used to form the permeable composite capstone layer can be bonded together with a resin (e.g., epoxy, urethane, acrylic, styrene butadiene, silicone, etc.); however, this is not required. In one specific, non-limiting example, the permeable composite capstone layer includes recycled concrete and recycled rubber bonded together with urethane; however, this is not required. The permeable composite capstone layer can be formed from one or more materials, which permit easy mixing, can be applied with standard troweling and/or paving techniques, and/or can be cured in place; however, this is not required. In one non-limiting embodiment, the permeable composite capstone layer is at least abrasion resistant, freeze/thaw resistant, and/or strong enough to support major loads (e.g., the weight of a person, car, truck, train, bus, etc.).

The ratio of resin to base material in the permeable composite capstone layer can be from about 1:0.5 to about 1:50 (and all values and ranges therebetween), more typically about 1:1.001 to about 1:20, yet more typically from about 1:2 to about 1:16, and still more typically from about 1:5 to about 1:10; however, other ratios can be used. In one specific embodiment, the ratio of resin to base material is 1:8; however, this is not required. Generally, the ratio of resin to base material can be selected based on the size of the one or more base materials used; however, this is not required. Alternatively, the ratio of resin to base material can be selected such that the surface water runoff is allowed to pass through the permeable composite capstone layer at a rate of at least 0.25 inch of water per square foot per hour (e.g., 0.25-5000 inches of water per square foot per hour and all values and ranges therebetween, 0.5-800 inches of water per square foot per hour, 1-600 inches of water per square foot per hour, etc.); however, this is not required. The ratio of resin to base material can be selected to control the volume of water that can flow through the permeable composite capstone layer over a period of time. Generally, the more resin that is used, the smaller the volume of water that can flow through the permeable composite capstone layer over a period of time. The amount of base material in the permeable composite capstone layer can be used to control the wear rate of the permeable composite capstone layer over time. When the permeable composite capstone layer has larger amounts of resin, the wear resistance of the permeable composite capstone layer generally increases; however, this is not required. As such, the ratio of resin to base material can be selected to control the permeability, porosity, density and/or wear resistance of the permeable composite capstone layer; however, this is not required.

According to one non-limiting embodiment of the present invention, the permeable composite capstone layer can include about 10 to about 80 wt. % of a first base material (and all values and ranges therebetween), about 10 to about 80 wt. % of a second base material (and all values and ranges therebetween), about 5 to about 60 wt. % of a binding resin (and all values and ranges therebetween), and less than about 5 wt. % of an additive (and all values and ranges therebetween); however, this is not required. In another non-limiting embodiment, the permeable composite capstone layer can include about 20 to about 80 wt. % of a first base material, about 20 to about 80 wt. % of a second base material, about 10 to about 20 wt. % of a binding resin, and less than about 2 wt. % of an additive; however, this is not required. According to one specific non-limiting example of the present invention, the permeable composite capstone layer can be a 50/50 mixture of recycled concrete and recycled rubber, blended together with 16% of a moisture-cured urethane; however, this is not required. One non-limiting advantage of using a rubber-based material in the permeable composite capstone layer is that the rubber exhibits rebound and flexibility; however, other or additional materials can be used in the permeable composite capstone layer to obtain such a feature of the permeable composite capstone layer. One non-limiting additive that can be used are silanes. Silanes can be used in the capstone layer to promote adhesion between the different solid components. Another non-limiting additive that can be used in the capstone layer are pigments. A variety of pigments and pigment dispersions can optionally be used in the capstone layer to provide coloring.

The dimensions and shape of the permeable composite capstone layer can vary according to the size and shape of the site in which the surface water mitigation structure is to be used. Similarly, the dimensions and shape of the permeable composite capstone layer can be selected based on desired flow rates and quantity of water to be treated and/or filtered. Generally, the permeable composite capstone layer is relatively thin compared to its surface area. In non-limiting arrangements, the ratio of depth to surface area is typically at least 1:100, more typically at least 1:50, and still more typically at least 1:20; however, this is not required. As can be appreciated, other ratios can be used based on the desired application. Generally, the permeable composite capstone layer has an average thickness of at least 0.25 inches, typically about 0.5-20 inches (and all values and ranges therebetween), and more typically about 1-5 inches.

The permeable composite capstone layer can include a flow gradient wherein the porosity permeability at or near the top surface is substantially greater than the permeability at or near the bottom surface; however, this is not required. As such, the flow gradient can allow for a hydraulic gradient or pressure for the purpose of forcing water downward and through the permeable composite capstone layer. Also, the flow gradient can optionally spread out a recharge area, thus increasing the amount of water into the storage medium. Also, the flow gradient can reduce the formation of black ice on the surface during cold conditions.

According to another and/or alternative non-limiting aspect of the invention, the permeable composite capstone layer can serve the purpose of a support layer and/or a collection drain. As such, the permeable composite capstone layer can cause the surface water to flow through the permeable composite capstone layer and into the porous storage medium layer, thereby minimizing and/or reducing runoff from the surface of the permeable composite capstone layer; however, this is not required. As can be appreciated, one or more drains can be inserted in the permeable composite capstone layer to also facilitate in minimizing and/or reducing runoff from the top surface of the permeable composite capstone layer; however, this is not required. As can be appreciated, curbs and/or raised edges can be used with and/or formed in the permeable composite capstone layer to facilitate in minimizing and/or reducing runoff from the top surface of the permeable composite capstone layer; however, this is not required. The top surface of the permeable composite capstone layer can be sloped to facilitate in minimizing and/or reducing runoff from the top surface of the permeable composite capstone layer; however, this is not required.

In use, the runoff on the surface of the permeable composite capstone layer passes downwardly through the permeable composite capstone layer and into the porous storage medium layer that is located below the permeable composite capstone layer. The permeability of the permeable composite capstone layer can be selected to control the flowrate of runoff through the permeable composite capstone layer so as to prevent oversaturation of the porous storage medium layer that is located below the permeable composite capstone layer; however, this is not required.

In one non-limiting aspect of the invention, a watertight and/or impermeable material can be disposed along one or more sides of the top surface of the permeable composite capstone layer to allow runoff to flow through the permeable composite capstone layer by the force of gravity into the porous storage medium layer, but inhibit or prevent the flow of runoff from the permeable composite capstone layer and into the surrounding ground.

According to another and/or alternative non-limiting aspect of the invention, the porous storage medium layer is a fluid-absorbent layer; however, this is not required. The porous storage medium layer can be a water absorbing material; however, this is not required. The porous storage medium layer is designed to retain sufficient amounts of fluid to support remediating agent activity, yet durable enough to support loads of the permeable composite capstone layer.

The porous storage medium layer can be made from one or more materials and associated void spaces. In non-limiting embodiments, the porous storage medium layer can be one or more storage medium layer components selected from the group consisting of shale, slate, expanded shale, and/or expanded slate. One non-limiting advantage of using shale, slate, expanded shale and expanded slate is that these materials have the unique ability to retain large amounts of water while still retaining support/compact strength. In non-limiting embodiments, the material of the porous storage medium layer includes a lightweight material (e.g., shale, slate, etc.); however, this is not required. In other and/or alternative non-limiting embodiments, the material of the porous storage medium layer includes a storage medium layer component that is lightweight (e.g., expanded shale, expanded slate, etc.); however, this is not required. One non-limiting advantage of using a storage medium layer component having lightweight components (LWAs) is that unstable soil can be converted into usable land. As such, the LWA can be used over compressible soils and still have the ability to support extreme loads (e.g., roadways, sidewalks, train tracks, runways, etc.). The unique structure of the storage medium layer components provides benefits of hydraulic conductivity, such that the storage medium layer components allows for fast free drainage, and a high angle of internal friction, which provides increased strength and stability. Further, the use of storage medium layer components can reduce and/or remove various amounts of hazardous chemicals (e.g., phosphorous, arsenic, hydrocarbons, etc.) due to its outer layer molecular charge. In non-limiting embodiments, one cubic yard of storage medium layer components can retain more than 10 gallons of water, typically more than 25 gallons of water, and more typically more than 50 gallons of water; however, this is not required. The one or more storage medium layer components can vary in size and is in the range from about 0.01 mm to about 200 mm (and all values and ranges therebetween), more typically from about 0.10 mm to about 100 mm, and still more typically from about 0.2 mm to about 50 mm; however, other sizes may be used. In one specific embodiment, the average diameter of the storage medium layer components is 20 nm; however, this is not required. According to another and/or alternative non-limiting aspect of the invention, 3/8 x No. 8 mesh size storage medium layer components can be used; however, this is not required. As such, a 3/8 x No. 8 mesh size provides improved compaction and water storage properties. The amount of storage medium layer components used can be selected based on the amount of water to be stored. For example, in one non-limiting arrangement, for every 50 gallons of water to be treated by the storage medium layer components, 1 cubic yard of LWA can be used; however, this is not required. The LWAs have a hydraulic conductivity that allows for fast free drainage and has a high angle of internal friction of greater than about 30-60 degrees (e.g., 40 degrees) that provides strength and stability. The LWAs can remove or reduce amounts of phosphorus and arsenic due to its outer layer charge. The LWAs are a good medium for aerobic digestion of runoff contaminants; however, this is not required.

The dimensions and shape of the porous storage medium layer can vary according to the size and shape of the site in which the surface water mitigation structure is to be used. Similarly, the dimensions and shape of the porous storage medium layer can be selected based on desired flow rates and quantity of water to be treated and/or filtered. Generally, the porous storage medium layer is relatively thin compared to its lateral dimension (i.e., its area). In non-limiting arrangements, the ratio of depth to surface area is typically at least 1:100 (and all values and ranges therebetween), more typically at least 1:50, and still more typically at least 1:20; however, this is not required. As can be appreciated, other ratios can be used based on the desired application. The thickness of the porous storage medium layer is generally greater than the thickness of the permeable composite capstone layer; however, this is not required. In one non-limiting arrangement, the thickness ratio of the permeable composite capstone layer to the porous storage medium layer is generally 1:1-1000 (and all values and ranges therebetween), and typically 1:1-20, and more typically 1:1-10.

The porous storage medium layer can include a flow gradient wherein the porosity at or near the top is substantially greater than the porosity at or near the bottom surface; however, this is not required. As such, the porosity variation can be used to effect the hydraulic gradient or pressure gradient for the purpose of forcing water downward and through the porous storage medium layer; however, this is not required.

Contaminated water entering the porous storage medium layer is designed to be temporarily retained within the porous storage medium layer. Runoff from the overlying permeable composite capstone layer enters into the porous storage medium layer. The porous storage medium layer can be designed to be an absorbent layer so as to facilitate the activity of one or more remediating agents provided therein and to allow the now-captured water to be chemically, physically and/or biologically digested of contaminants while the water is contained in the porous storage medium layer. In one non-limiting embodiment, the porous storage medium layer treats the stored water for a mean retaining time of at least about 0.1 days, typically at least about 0.5 days, more typically at least about 1 day, still more typically at least about 3-5 days, and even more typically at least about 5-12 days; however, other time periods can be used. In one specific embodiment, the water is retained in the porous storage medium layer for about 3-8 days (e.g., 6 days); however, this is not required. In addition to the biological digestion of contaminants, oxidation reactions and/or other aerobic conversions of some contaminants may occur in the porous storage medium layer.

The porous storage medium layer can include a watertight and/or impermeable material on one or more sides of the porous storage medium layer, thereby forming water-impermeable sides of the porous storage medium layer; however, this is not required. The watertight and/or impermeable material along the sides of the porous storage medium layer can prevent the flow of water from flowing out the sides of the porous storage medium layer and only allow the water to flow into the top of the porous storage medium layer and out the bottom of the porous storage medium layer and out any controlled side openings in the porous storage medium layer; however, this is not required.

According to another and/or alternative non-limiting aspect of the invention, the porous storage medium layer can serve the purpose of a support layer and/or a collection basin; however, this is not required. In yet another and/or alternative non-limiting aspect of the invention, the porous storage medium layer can support the growth of microbes (i.e., remediating agents) in void spaces and internal particle cracks; however, this is not required. As such, additional air, water and/or nutrients can be supplemented into the porous storage medium layer for the purpose of supporting and/or encouraging the growth and activity of the one or more microbes provided therein; however, this is not required.

According to another and/or alternative non-limiting embodiment of the present invention, the porous storage medium layer can include a mixture of one or more expanded lightweight components and one or more biological agents (e.g., microbes, etc.); however this is not required. The porous storage medium layer can included one or more types of microbes. The amount or concentration of the two or more types of microbes (when used) can be the same or different. According to another and/or alternative non-limiting embodiment of the present invention, the porous storage medium layer can include about 5 to about 95 wt. % of a first storage medium layer component (and all values and ranges therebetween), about 0 to about 85 wt. % of a second storage medium layer component (and all values and ranges therebetween), about 0.1 to about 30 wt. % of a first remediating agent (e.g., microbe, etc.) (and all values and ranges therebetween), about 0 to about 30 wt. % of a second remediating agent (e.g., microbe, etc.) (and all values and ranges therebetween), and less than about 10 wt. % of an additive (and all values and ranges therebetween); however, this is not required. According to another and/or alternative non-limiting embodiment of the present invention, the porous storage medium layer can include about 10 to about 80 wt. % of a first storage medium layer component, about 10 to about 80 wt. % of a second storage medium layer component, about 1 to about 30 wt. % of a first remediating agent (e.g., microbe, etc.), about 1 to about 30 wt. % of a second remediating agents (e.g., microbe, etc.), and less than about 10 wt. % of an additive; however, this is not required. Non-limiting additives that can be used in the porous storage medium layer include solvents, acids, bases, oxidants, surfactants, cosolvents, vitamins, nutrients, chelants, and/or nanomaterials. One or more of these additives can be post added through the permeable capstone layer to meet mitigation needs in response to specific contamination mitigation requirements.

In one non-limiting embodiment, the porous storage medium layer is composed of approximately 60-99 vol. % (and all values and ranges therebetween) storage medium layer component; however, this is not required. The storage medium layer component can be selected to provide improved water retention characteristics, strength characteristics, and/or microbial growth support characteristics; however, this is not required. The average particle size of the storage medium layer component can be at least 0.1 mm in diameter; however, this is not required. The microbes in the porous storage medium layer constitute at least 1 vol. % of the dry porous storage medium layer and generally about 2 to 20 vol. % of the dry porous storage medium layer; however, this is not required. In the above-described non-limiting embodiment, the porous storage medium layer provides a flow rate of the runoff in the porous storage medium layer of about 0.001- to 0.5 feet per second per square foot of surface area and all values and ranges therebetween (e.g., 0.020 feet per second per square foot of surface area). One or more additives may be optionally added to the porous storage medium layer to provide improved water retention, strength, and/or microbial growth support characteristics; however, this is not required. The porous storage medium layer provides a high contaminant removal rate due to the retention time of the contaminated water within the porous storage medium layer.

According to another and/or alternative non-limiting aspect of the present invention, the porous storage medium layer can be impregnated with one or more biological agents prior to and/or after the permeable composite capstone layer is laid on top of the porous storage medium layer. As can be appreciated, additional microbes can be added to the porous storage medium layer after the permeable composite capstone layer is laid on top of the porous storage medium layer. In one non-limiting embodiment, the porous storage medium layer includes 1 to 5 different types of microbes. The one or more microbes can be class 3 naturally occurring microbes; however, this is not required.

According to another and/or alternative non-limiting aspect of the invention, the one or more microbes in the porous storage medium layer can be selected for the removal of petroleum-based contaminants (e.g., hydrocarbons) from the runoff. As such, the microbes can include bacteria that can consume hydrocarbons (e.g., oil, grease, gasoline, etc.) and convert it into carbon dioxide, water, and cellular material, as illustrated by the following reaction:

HₓC_{y}+microbes→CO₂+H₂O

wherein x and y are numbers defining the contaminant hydrocarbon; however, this is not required. Upon partial or full removal of the contaminants (e.g., hydrocarbons, etc.) from the runoff, the remaining microbes in the porous storage medium layer can expire due to lack of “food” or become dormant; however, this is not required.

In non-limiting embodiments, the microbes in the porous storage medium layer can be selected to treat certain types of contaminants in the runoff; however, this is not required. While the present non-limiting example relates to the removal of hydrocarbons from runoff, the present application is amenable to other like applications, such as, for example, the removal of perchlorate, nitrate, salts, organic compounds, inorganic compounds, metals, etc., from runoff; however, this is not required. As can be appreciated, one or more contaminants can be removed sequentially with the use of one type of microbe. For example, the microbes can consume an organic contaminant (e.g., hydrocarbon, etc.) which can lead to a chemical reaction that removes salts; however, this is not required.

In another and/or alternative non-limiting aspect of the invention, the one or more microbes used in the porous storage medium layer can include those that are: 1) naturally occurring, 2) non-genetically modified, and/or 3) those that can be concentrated in solutions; however, this is not required. In one specific, non-limiting embodiment, two microbes can be used, wherein the first microbe can be selected to be a petroleum distillate and wherein the second microbe can be selected to be a phosphate distillate; however, this is not required. The petroleum distillate microbe can be selected from a group of petroleum-degrading bacteria consisting of Micrococcus, Arthrobacter, Rhodococcus, etc. The phosphate distillate microbe can be selected from a group of phosphate solubilizing bacteria consisting of Pantoea aggiomerans, Microbacterium laevaniformans, Pseudomonas putida, etc. As can be appreciated, the type of microbe can be selected based on the desired contaminant to be removed. Non-limiting examples of such microbes include Achromobacter, Aspergillys, Bacillus, Candida, Cladosporium, Corynebacterium, Myrothecium, Punicillium, Phialophora, Phodothorula, Streptomyces, Trichoderma, and/or a blend of other aerobic and/or anaerobic bacteria.

In another and/or alternative non-limiting aspect of the invention, the one or more microbes can be concentrated in solutions that permit the microbes to be added to the porous storage medium layer: 1) after it has been laid in the ground surface and prior to the permeable composite capstone layer being laid on top of the porous storage medium layer; and/or 2) through the permeable composite capstone layer after the permeable composite capstone has been laid on top of the porous storage medium layer; however, this is not required. The solution of microbes can include one or more microbes (aerobic, anaerobic, and/or facultative) in water; however, this is not required. The solution can contain one or more additives to support the growth of said microbes; however, this is not required. The solution can be prepared by soaking the microbes in water for from about 0.1 hours to about 24 hours or more, more typically about 0.5 hours to about 15 hours, and still more typically about 1 hour to about 10 hours; however, this is not required. In one specific embodiment, the microbes can be soaked in water for 3-8 hours; however, this is not required. In one non-limiting example, about 100 grams of microbes are soaked in 10 gallons of water for 5-7 hours. The resulting solution can be diluted (100 to 2,000 parts of concentrate to 1,000,000 parts of water, etc.) to form the solution that is to be used to populate the porous storage medium layer with microbes; however, this is not required. The concentration of microbes is typically from about 50 ppm to about 500 ppm (and all values and ranges therebetween), more typically from about 100 ppm to about 400 ppm, and still more typically from about 150 ppm to about 350 ppm. In specific embodiments, about 200-270 ppm is used; however, this is not required.

One non-limiting advantage to using such microbes in the porous storage medium layer is that, rather than consuming energy to function as a filtration system of the contaminants in the water, the microbes end up producing a net gain of energy, specifically as they release energy (e.g., heat, etc.) that is stored in the bonds of organic compounds (e.g., the bonds within hydrocarbons, etc.), which produced energy could be collected and reused; however, this is not required.

Introducing non-genetically modified microbes into the storage medium layer component (i.e., the LWA) allows the entire surface water mitigation structure system to function as a septic system and is capable to removing contaminants from water without the use of any piping or tanks.

According to one non-limiting aspect of the present invention, the surface water mitigation structure of the present invention is capable of removing contaminants and/or pollutants from water (e.g., storm water runoff, waste water runoff, etc.) by subjecting the water to a multi-layered filtration and treatment system. After the water has been treated by the surface water mitigation structure, the treated water can be discharged to the ground, the surface, and/or a drainage system.

The flow rate of water through the surface water mitigation structure can be increased in a number of ways, including: 1) increasing the permeability of the permeable composite capstone layer; 2) reducing the area of the porous storage medium layer; 3) reducing the absorbency of the porous storage medium layer; and/or, 4) reducing the amount of remediating agents (e.g., microbes, etc.) in the porous storage medium layer.

The contaminant removal can be increased in a number of ways, including: 1) reducing the permeability of the permeable composite capstone layer; 2) increasing the area of the porous storage medium layer; 3) increasing the absorbency of the porous storage medium layer; 4) increasing the amount of microbes in the porous storage medium layer; 5) increasing the quality of microbes; and/or 6) optimizing the environment for the microbes, e.g. aerate, add limiting micronutrient, etc.

According to another and/or alternative non-limiting aspect of the present invention, the unique structure of the surface water mitigation structure permits air to circulate through both the permeable composite capstone layer and the porous storage medium layer upper layer; however, this is not required. As such, the microbes in the porous storage medium layer can be supplied with a continuous supply of fresh air to aid in the digestion of the contaminants.

According to another and/or alternative non-limiting aspect of the present invention, the surface water mitigation structure of the present invention can be used as an environmentally friendly system to treat surface water runoff so as to reduce or eliminate harm to the environment from the surface water runoff. The surface water mitigation structure can also be used to reduce the amount of surface water that is processed by a water treatment plant. Currently, many impervious paved surfaces in an urban area include drains that direct surface water from a rain shower or the like to a water treatment plant. During periods of heavy rain, the water treatment plant can be overwhelmed due to a sudden influx of surface water that has drained from paved surfaces. During such times, the surface water is sometimes diverted into the environment due to the overcapacity of the water treatment plant. The surface water mitigation structure of the present invention can be used to eliminate the need to treat surface water that has fallen on the surface water mitigation structure by a water treatment plant, thereby reducing the volume of surface water needed to be treated by a water treatment plant; however, this is not required. Large impervious paved area such as parking lots, etc. that include the surface water mitigation structure of the present invention can reduce or eliminate the need for drains or retention ponds; however, this is not required. For example, a parking lot, pathway, etc. that includes the surface water mitigation structure of the present invention can be absent drains or retention ponds. A curb and/or other type of barrier perimeter can optionally be positioned about all or a portion of a perimeter of a surface that includes the surface water mitigation structure of the present invention so as to retain surface water on the surface water mitigation structure until such water flows through the surface water mitigation structure; however, this is not required. The height of such curb and/or other type of barrier perimeter (when used) above the top surface of the surface water mitigation structure is non-limiting (e.g., 0.25-10 inches and all values and ranges therebetween). As can be appreciated, when a curb and/or other type of barrier perimeter is used in conjunction with the surface water mitigation structure of the present invention, a raised drain located on the surface water mitigation structure and/or a drain located adjacent to the curb and/or other type of barrier perimeter to drain surface water on the surface of the surface water mitigation structure when the surface water mitigation structure cannot process the surface water at a fast enough rate; however, this is not required. For example, one or more raised drains that have a top surface elevated at some distance above the top surface of the surface water mitigation structure (e.g., 0.5-6 inches and all values and ranges therebetween) and generally at the same height or lower than the top surface of the curb and/or other type of barrier perimeter can be used to drain the surface water from the top surface of the surface water mitigation structure when the height of the water on the surface of the surface water mitigation structure rises to the height of the top surface of the one or more drains. In another or additional arrangement, one or more drains can be located adjacent to the curb and/or other type of barrier perimeter so as to receive surface water that has fallen on the surface water mitigation structure and has overflowed the curb and/or other type of barrier perimeter of the surface water mitigation structure. In these examples, the surface water mitigation structure is used process all of the surface water that has fallen on the surface water mitigation structure except in situations where the rainfall rate is too great for the surface water mitigation structure to process all of the surface water. In such situations, the excess water can be captured by a drain; however, the amount of water that flows into the drain is reduced by the amount of water that is processed by the surface water mitigation structure.

According to one non-limiting aspect of the present invention, a method of producing a surface water mitigation structure can include the steps of: 1) selecting one or more base materials for use in a permeable composite capstone layer; 2) selecting one or more resins to bind the one or more base materials of the permeable composite capstone layer; 3) mixing the one or more base materials with the one or more resins until the one or more base materials are wetted; 4) selecting one or more storage medium layer components for the porous storage medium layer; 5) digging up a ground surface for insertion of the porous storage medium layer; 6) inserting the porous storage medium layer upper layer on a ground surface or prepared ground surface; 7) impregnating the porous storage medium layer with one or more microbes; 8) placing the uncured mixture of base materials and one or more resins of the permeable composite capstone layer on top of the porous storage medium layer; 9) allowing the one or more base materials and one or more resins of the permeable composite capstone layer to cure. The curing of the one or more resins of the permeable composite capstone layer results in the formation of a durable permeable composite capstone layer. The curing of the one or more resins can optionally result in the bonding of the permeable composite capstone layer to the top surface of the porous storage medium layer. After the curing of the one or more resins of the permeable composite capstone layer, one or more powered microbes and/or one or more microbes via solution can be optionally added to the top surface of the permeable composite capstone layer so as to initially or further charge the porous storage medium layer with one or more remediating agents.

According to another and/or alternative non-limiting aspect of the present invention, a method of treating and/or filtering runoff can include the steps of: 1) capturing contaminated runoff on a surface via a permeable composite capstone layer, 2) treating the captured runoff in a porous storage medium layer that includes one or more remediating agents, and 3) allowing the treated water to disperse in the ground about the mitigation structure of the present invention. As can be appreciated, the permeable composite capstone layer can also function as an initial filtration system for the runoff to prevent large objects or materials from passing through the permeable composite capstone layer and into the porous storage medium layer.

One non-limiting object of the present invention is the provision of an improved surface water mitigation structure that can effectively treat and remove pollutants, contaminants, etc. from surface water runoff.

Another and/or alternative non-limiting object of the present invention is the provision of an improved surface water mitigation structure where the entire system does not require any piping and/or tanks.

Another and/or alternative non-limiting object of the present invention is the provision of an improved surface water mitigation structure wherein any contaminated water that enters the surface water mitigation structure can be processed naturally.

Another and/or alternative non-limiting object of the present invention is the provision of an improved surface water mitigation structure wherein one or more microbes embedded within said surface water mitigation structure can be used to remove water contaminants.

Another and/or alternative non-limiting object of the present invention is the provision of an improved surface water mitigation structure wherein the only or primary by-products from such contaminated water runoff treatment are clean water and carbon dioxide.

Another and/or alternative non-limiting object of the present invention is the provision of an improved surface water mitigation structure wherein chlorine is not used in the processing of contaminated water runoff.

Another and/or alternative non-limiting object of the present invention is the provision of an improved surface water mitigation structure wherein the contaminated runoff is captured and processed before it is released to a sewer, groundwater and/or the ground surrounding the improved surface water mitigation structure.

Yet another and/or alternative non-limiting object of the present invention is the provision of an improved surface water mitigation structure wherein the entire system is able to support substantial loads, collect water, store water, and treat/remove contaminants.

Still yet another and/or alternative non-limiting object of the present invention is the provision of an improved surface water mitigation structure which is capable of treating water contaminants chemically, physically, and/or biologically.

Another and/or alternative non-limiting object of the present invention is the provision of an improved surface water mitigation structure that does not require any piping or tanks.

Still another and/or alternative non-limiting object of the present invention is the provision of an improved surface water mitigation structure that functions as both a support layer and as a collection drain.

These and other objects, features and advantages of the present invention will become apparent from the subsequent description taken in conjunction with the accompanying drawings.

### BRIEF DESCRIPTION OF THE DRAWINGS

Reference may now be made to the drawings, which illustrate various non-limiting embodiments that the invention may take in physical form and in certain parts and arrangement of parts wherein:

FIG. 1 is a cross-sectional perspective illustration of the surface water mitigation structure according to one non-limiting aspect of the present invention;

FIG. 2 is a perspective illustration of a section of the permeable composite capstone layer of FIG. 1;

FIG. 3 is a perspective illustration of one non-limiting base material that can be used to at least partially form the permeable composite capstone layer of FIG. 1;

FIG. 4 is a perspective illustration of a comparison of rain fall on a prior art paved surface and the surface water mitigation structure of FIG. 1; and,

FIG. 5 is an illustration of a sidewalk or path formed by the surface water mitigation structure of the present invention and also illustrates an optional curb structure along the outer perimeter of the top surface of the surface water mitigation structure.

### DETAILED DESCRIPTION OF THE NON-LIMITING EMBODIMENTS

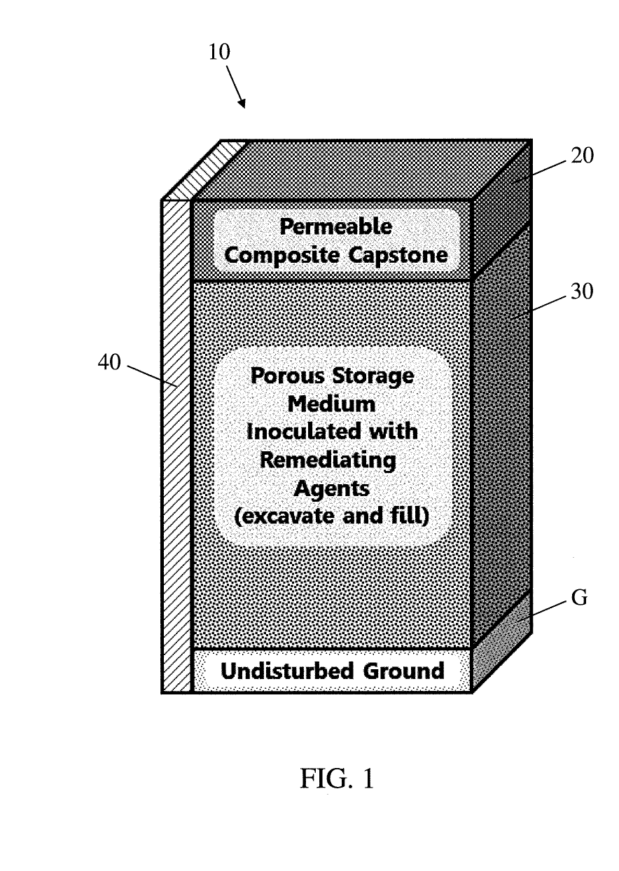

Referring now to the drawings, wherein the showings are for the purpose of illustrating at least one non-limiting embodiment of the invention only and not for the purpose of limiting the invention, FIGS. 1-5 illustrate a surface water mitigation structure in accordance with the present invention.

The present invention is directed to a surface water mitigation structure that can be used as a water treatment and/or filtration system which is durable enough to be used in outdoor applications (e.g., roadways, parking lots, sidewalks, cart paths, bicycle paths, urban tree surrounds, horse stalls, drainage basins, etc.), and which surface water mitigation structure and/or topping has a multi-layered structure that includes remediating agents used to at least partially treat contaminants that flow through the surface water mitigation structure.

As illustrated in FIG. 1, the surface water mitigation structure 10 includes at least two layers, namely a) a permeable composite capstone layer 20 and b) a porous storage medium layer 30. The permeable composite capstone layer 20 is positioned above the porous storage medium layer 30, and the porous storage medium layer 30 is positioned above a ground surface G. The permeable composite capstone layer 20 is configured so that it can support substantial loads while also being pervious enough to allow top water runoff to pass through the permeable composite capstone layer. The porous storage medium layer 30 is configured to absorb and/or hold water that has passed through the permeable composite capstone layer 20. The porous storage medium layer is designed to at least contain and/or be inoculated with one or more remediating agents that are designed to break down contaminants in the runoff that has passed through the permeable composite capstone layer. The porous storage medium layer is also typically designed to retain and/or absorb the runoff for a period of time (e.g., 2 minutes to 10 days and all values and ranges therebetween) to allow the remediating agents to break down the contaminants before the runoff enters the surrounding environment. In one non-limiting embodiment, the average residence time of the runoff in the porous storage medium layer is at least about 5 minutes, and typically at least about 10 minutes.

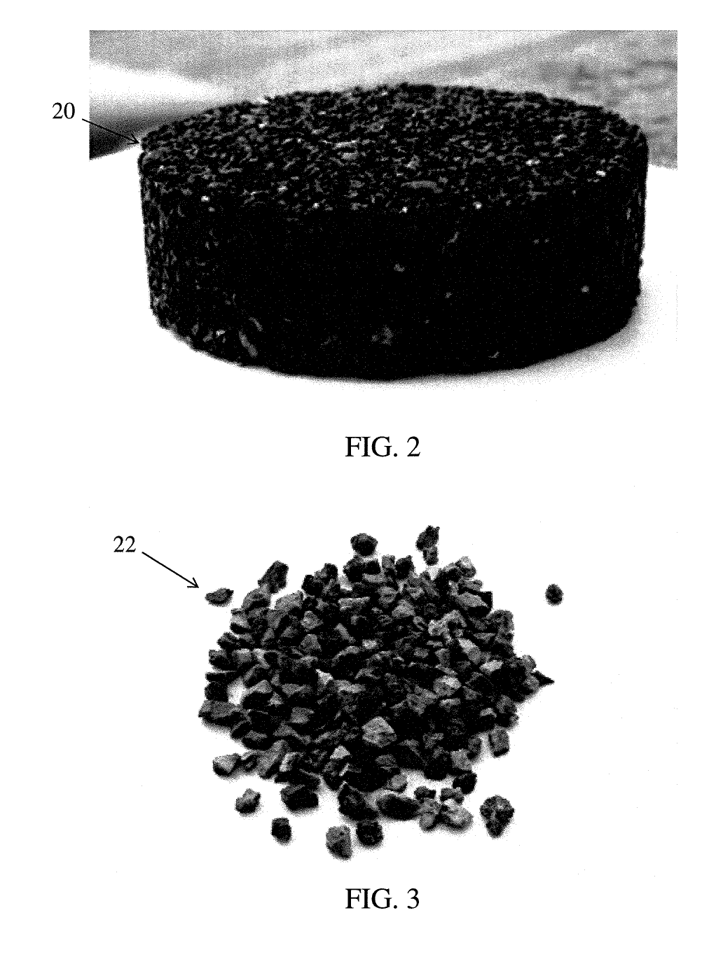

Referring now to FIGS. 1-4, the permeable composite capstone layer 20 can be formed from a base material formed of particles of natural materials (e.g., limestone, shale, slate, sandstone, quartz, feldspar, dolomite, obsidian, mica, diorite, flint, granite, etc.) and/or one or more man-made materials (e.g., glass, rubber, recycled concrete, recycled asphalt, expanded shale, expanded slate, recycled plastic, etc.) 22 which are bonded together with a resin (e.g., epoxy, urethane, acrylic, styrene butadiene, silicone, etc.). FIG. 3 illustrates granules of base material that can be used to form the permeable composite capstone layer 20. FIG. 2 illustrates a sample of a permeable composite capstone layer 20 wherein the base materials bonded together by a resin to form a porous and durable structure. In one specific, non-limiting example, the permeable composite capstone layer includes recycled concrete and recycled rubber bonded together with urethane. The average particle size of the base material is 0.5 mm to 100 mm (and all values and ranges therebetween) based on ISO 14688-1:2002, and typically about 1 mm to 60 mm based on ISO 14688-1:2002, and more typically 3 mm-30 mm based on ISO 14688-1:2002 based on ISO 14688-1:2002. The base material generally constitutes 55 wt. %-99.5 wt. % (and all values and ranges therebetween) of the permeable composite capstone layer, and the binder generally constitutes 0.5 wt. %-45 wt. % (and all values and ranges therebetween) of the permeable composite capstone layer. The permeable composite capstone layer can also include one or more additives.

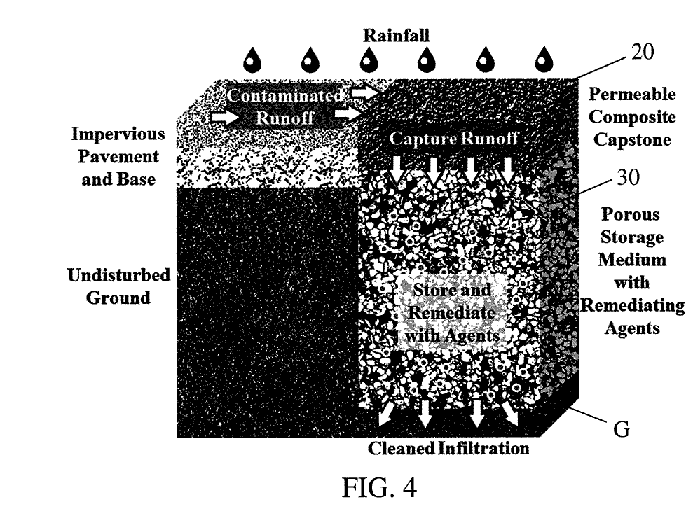

Generally, the permeable composite capstone layer is relatively thin compared to its surface area. In one non-limiting embodiment, the ratio of depth of the permeable composite capstone layer to the surface area of the permeable composite capstone layer is at least 1:50, and has an average thickness of at least 1 inch, and typically about 1-8 inches. As illustrated in FIGS. 1 and 4, the thickness of the permeable composite capstone layer 20 is less than the thickness of the porous storage medium layer 30. The thickness ratio of the permeable composite capstone layer to the porous storage medium layer is generally 1:1.2-500, and typically 1:3-15.

The permeable composite capstone layer is typically configured to be abrasion resistant, freeze/thaw resistant, and/or strong enough to support major loads (e.g., the weight of a person, car, truck, train, bus, etc.). In one non-limiting embodiment, the permeable composite capstone layer has a composition and thickness to support a load on a top surface of the permeable composite capstone layer of at least 50 lbs./ft.² without breaking under such load, typically at least 100 lbs./ft.², more typically at least 500 lbs./ft.² without breaking under such load, and still more typically at least 1000 lbs./ft.² without breaking under such load.

The ratio of resin to base material in the permeable composite capstone layer is typically about 1:2 to about 1:16. In one specific embodiment, the ratio of resin to base material is 1:4-10. The permeable composite capstone layer is configured to allow water to pass through the permeable composite capstone layer at a rate of at least 1 inch of water per square foot per hour, and typically at least 2 inches of water per square foot per hour.

The porous storage medium layer 30 is configured to retain sufficient amounts of fluid to support remediating agent activity, yet durable enough to support loads of the permeable composite capstone layer. The porous storage medium layer can be made from one or more materials and associated void spaces. In non-limiting embodiments, the porous storage medium layer can include one or more storage medium layer components selected from the group consisting of shale, slate, expanded shale, and/or expanded slate. The one or more storage medium layer components used to at least partially form the porous storage medium layer is about 0.10 mm to about 100 mm (and all values and ranges therebetween). The amount of storage medium layer components included in the porous storage medium layer is generally selected based on the amount of water to be stored or retained for a period of time in the porous storage medium layer.

Water and other liquids that enter the porous storage medium layer after passing through the permeable composite capstone layer is designed to be temporarily retained within the porous storage medium layer. The porous storage medium layer generally is designed to retain water and other liquids for at least about 0.1 days.

In one non-limiting arrangement, the thickness of the permeable composite capstone layer 20 is about 0.1-5 inches, typically 0.5-3 inches, and more typically 1-2 inches, and can with loads without cracking of 500-200,000 lbs./ft.², typically 1000-100,000 lbs./ft.², more typically 5000-50,000 lbs./ft.², and still more typically 7500-20,000 lbs./ft.². In another or alternative non-limiting arrangement, the thickness of the porous storage medium layer 30 is about 0.25-100 ft., typically 0.5-50 ft., and more typically about 1-20 ft. The composition of the porous storage medium layer 30 is generally selected such that each ton (i.e., 2000 lbs.) of the porous storage medium layer can store about 10-200 gal. of water, typically 25-100 gal. of water, and more typically about 40-75 gal. of water.

The permeable composite capstone layer and/or the porous storage medium layer can optionally include a watertight and/or impermeable material 40 on one or more sides of the permeable composite capstone layer and/or the porous storage medium layer. The watertight and/or impermeable material can prevent the flow of water and other liquids from flowing out the sides of the permeable composite capstone layer and/or porous storage medium layer and only allow the water and other liquids to flow through the permeable composite capstone layer and into the top of the porous storage medium layer and out the bottom of the porous storage medium layer and out any controlled side openings in the porous storage medium layer; however, this is not required. The porous storage medium layer can serve the purpose of a support layer and/or a collection basin. The porous storage medium layer can optionally support the growth of remediating agents in the form of microbes. The porous storage medium layer can optionally include water and/or nutrients for the purpose of supporting and/or encouraging the growth and activity of the one or more microbes in the porous storage medium layer.

The porous storage medium layer can include a mixture of one or more expanded lightweight storage medium layer components and one or more remediating agents. In one non-limiting configuration, the porous storage medium layer includes about 10 to about 99.9 wt. % of a first storage medium layer component, about 0 to about 89.9 wt. % of a second storage medium layer component, about 0.1 to about 30 wt. % of a first remediating agent, about 0 to about 30 wt. % of a second remediating agent, and less than about 10 wt. % of an additive. The dry porous storage medium layer is composed of approximately 65-98 vol. % storage medium layer components. The average particle size of the storage medium layer component is at least 0.2 mm in diameter; however, this is not required. The microbes in the porous storage medium layer constitute about 2-18 vol. % of the dry porous storage medium layer. The porous storage medium layer provides a flow rate of the runoff in the porous storage medium layer of about 0.001-1 feet per second per square foot of surface area (and all values and ranges therebetween).

Referring now to FIG. 4, there is a side-by-side comparison of a how surface water is treated when contacting the top surface of a prior art paved surface (as shown on the right side of FIG. 4) and when contacting the top surface of the surface water mitigation structure 10 of the present invention (as illustrated on the left side of FIG. 4). When a liquid contacts the top surface of the prior art paved surface, the liquid stays on the top surface of the prior art paved surface until it is washed away, such as by rain. The runoff from the prior art paved surface either drains into a drain or runs off into the surrounding environment. If the drain is not connected to a sewer system, the runoff enters into the surrounding environment. Runoff that includes contaminants that flow into the surrounding environment can potentially damage the surrounding environment. In contrast, when a liquid such contacts the top surface of the permeable composite capstone layer 20 of the surface water mitigation structure 10, the liquid may partially or fully pass through the permeable composite capstone layer. If the liquid only partially passes through the permeable composite capstone layer, when a significant amount of surface water such as from a rain storm falls on the permeable composite capstone layer, such surface water will eventually cause some or all of the liquid to pass through the permeable composite capstone layer. Once the liquid passes through the permeable composite capstone layer, the liquid contacts and is temporarily retained and/or absorbed in the one or more materials and/or voids in the porous storage medium layer. One or more contaminants in the liquid can be partially or fully broken down or eliminated by one or more remediating agents that are located in the porous storage medium layer. As such, when water exits the porous storage medium layer and into ground G, the amount of contaminates in the water are typically reduced. As such, the surface water mitigation structure of the present invention is capable of removing contaminants and/or pollutants from water (e.g., storm water runoff, waste water runoff, etc.) by subjecting the water to a multi-layered filtration and treatment system. After the water has been treated by the surface water mitigation structure, the treated water can be discharged to the ground, the surface, and/or a drainage system.

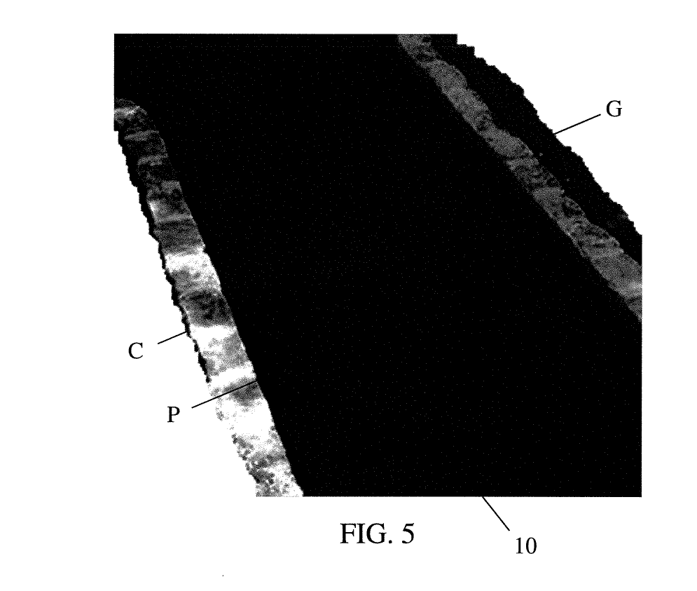

Referring now to FIG. 5, there is illustrated a path P that is formed of a surface water mitigation structure 10 in accordance with the present invention and an optional curb or border parameter C that is positioned between the top surface of the surface water mitigation structure 10 and the surface of ground G. The curb or border parameter can be used to partially or fully retain surface water on the top surface of the surface water mitigation structure until the surface water passes through permeable composite capstone layer 20 of the surface water mitigation structure 10.

During construction of the surface water mitigation structure, the porous storage medium layer is inserted onto the top of the ground surface. It is not uncommon that a portion of a ground surface is removed prior to the porous storage medium layer being inserted onto the top of the ground surface; however, this is not required. The one or more remediating agents in the porous storage medium layer can be included in the porous storage medium layer at the time that the porous storage medium layer is inserted on the ground surface and/or at some later time. After the porous storage medium layer has been applied to the ground surface, the permeable composite capstone layer is applied to the top of the porous storage medium layer. Generally, the permeable composite capstone layer is formed on the porous storage medium layer by applying a mixture of base material and uncured or partially cured resin to the top surface of the porous storage medium layer. After the resin in the permeable composite capstone layer has sufficiently cured, the surface water mitigation structure can be used. The one or more remediating agents for use in the porous storage medium layer can be initially inserted into the porous storage medium layer and/or the porous storage medium layer can be recharged with one or more remediating agents by pouring a solution of the one or more remediating agents onto the top surface of the permeable composite capstone layer; however, this is not required.

The invention has been described with reference to a preferred embodiment and alternatives thereof. It is believed that many modifications and alterations to the embodiment disclosed will readily suggest themselves to those skilled in the art upon reading and understanding the detailed description of the invention. It is intended to include all such modifications and alterations insofar as they come within the scope of the present invention.

In the claims:

1. A surface water mitigation structure comprising:
a permeable composite capstone layer, said permeable composite capstone layer is pervious and porous, said permeable composite capstone layer has a composition and thickness to support a load on a top surface of said permeable composite capstone layer of at least 50 lbs./ft.² without breaking under such load; and,
a porous storage medium layer positioned beneath said permeable composite capstone layer, said porous storage medium layer comprising a first storage medium layer component that is a water-absorbent material, and void spaces;
wherein at least a portion of a top surface of said permeable composite capstone layer is in fluid communication with said porous storage medium layer to allow water on a top surface of said permeable composite capstone to flow into said porous storage medium layer.

2. The surface water mitigation structure of claim 1, wherein said permeable composite capstone layer is comprised of a first base material and resin.

3. The surface water mitigation structure of claim 2, wherein said first base material includes one or more materials selected from the group consisting of limestone, shale, slate, sandstone, quartz, feldspar, dolomite, obsidian, mica, diorite, flint, granite, glass, rubber, recycled concrete, recycled asphalt, expanded shale, expanded slate, and recycled plastic.

4. The surface water mitigation structure of claim 2, wherein said permeable composite capstone layer includes a second base material, said second base material is different from said first base material.

5. The surface water mitigation structure of claim 4, wherein said second base material includes one or more materials selected from the group consisting of limestone, shale, slate, sandstone, quartz, feldspar, dolomite, obsidian, mica, diorite, flint, granite, glass, rubber, recycled concrete, recycled asphalt, expanded shale, expanded slate, and recycled plastic.

6. The surface water mitigation structure of claim 2, wherein said resin includes one or more materials selected from the group consisting of epoxy, urethane, acrylic, styrene, butadiene, and silicone.

7. The surface water mitigation structure of claim 1, wherein said first storage medium layer component includes one or more materials selected from the group consisting of shale, slate, expanded shale, expanded slate, and other synthetic material.

8. The surface water mitigation structure of claim 1, wherein said porous storage medium layer includes one or more remediating agents.

9. The surface water mitigation structure of claim 8, wherein said remediating agents includes one or more microbes selected from the group consisting of Micrococcus, Arthrobacter, Rhodococcus, Pantoea aggiomerans, Microbacterium laevaniformans, Pseudomonas putida, Achromobacter, Aspergillys, Bacillus, Candida, Cladosporium, Corynebacterium, Myrothecium, Punicillium, Phialophora, Phodothorula, Streptomyces, and Trichoderma.

10. The surface water mitigation structure of claim 8, wherein said one or more remediating agents are 0.1 vol. % to 40 vol. % of said porous storage medium layer.

11. A method for at least partially removing contaminates in surface water comprising the steps of:
a. providing a surface water mitigation structure, said surface water mitigation structure comprising:
a permeable composite capstone layer, said permeable composite capstone layer is pervious and porous, said permeable composite capstone layer has a composition and thickness to support a load on a top surface of said permeable composite capstone layer of at least 50 lbs./ft.² without breaking under such load; and,
a porous storage medium layer positioned beneath said permeable composite capstone layer, said porous storage medium layer comprising a first storage medium layer component that is a water-absorbent material, and void spaces; wherein at least a portion of a top surface of said permeable composite capstone layer is in fluid communication with said porous storage medium layer to allow water on a top surface of said permeable composite capstone to flow into said porous storage medium layer;
b. inserting said surface water mitigation structure on a surface;
c. exposing said surface water mitigation structure to surface water such that water contacts said top surface of said permeable composite capstone layer and then flows through said permeable composite capstone layer and into said porous storage medium layer; and,
d. at least partially treating said surface water in said permeable composite capstone layer to reduce or eliminate one or more contaminates in said surface water.

12. The method of claim 11, wherein said permeable composite capstone layer is comprised of a first base material and resin.

13. The method of claim 12, wherein said first base material includes one or more materials selected from the group consisting of limestone, shale, slate, sandstone, quartz, feldspar, dolomite, obsidian, mica, diorite, flint, granite, glass, rubber, recycled concrete, recycled asphalt, expanded shale, expanded slate, and recycled plastic.

14. The method of claim 12, wherein said permeable composite capstone layer includes a second base material, said second base material is different from said first base material.

15. The method of claim 14, wherein said second base material includes one or more materials selected from the group consisting of limestone, shale, slate, sandstone, quartz, feldspar, dolomite, obsidian, mica, diorite, flint, granite, glass, rubber, recycled concrete, recycled asphalt, expanded shale, expanded slate, and recycled plastic.

16. The method of claim 12, wherein said resin includes one or more materials selected from the group consisting of epoxy, urethane, acrylic, styrene, butadiene, and silicone.

17. The method of claim 11, wherein said first storage medium layer component includes one or more materials selected from the group consisting of shale, slate, expanded shale, expanded slate, and other synthetic material.

18. The method of claim 11, wherein said porous storage medium layer includes one or more remediating agents.

19. The method of claim 18, wherein said remediating agents includes one or more microbes selected from the group consisting of Micrococcus, Arthrobacter, Rhodococcus, Pantoea aggiomerans, Microbacterium laevaniformans, Pseudomonas putida, Achromobacter, Aspergillys, Bacillus, Candida, Cladosporium, Corynebacterium, Myrothecium, Punicillium, Phialophora, Phodothorula, Streptomyces, and Trichoderma.

20. The method of claim 18, wherein said one or more remediating agents are 0.1 vol. % to 40 vol. % of said porous storage medium layer.

21. A method for forming a surface water mitigation structure on a ground surface comprising:
a. depositing a porous storage medium layer on the ground surface, said porous storage medium layer comprising first storage medium layer component that is a water-absorbent material, and void spaces; and,
b. inserting a permeable composite capstone layer on a top surface of said porous storage medium layer, said permeable composite capstone layer formed of a mixture of a first base material and a resin, said permeable composite capstone layer porous to water to enable surface water on a top surface of said permeable composite capstone layer to flow through said permeable composite capstone layer and into said porous storage medium layer.

22. The method of claim 21, wherein said step of inserting said permeable composite capstone layer on a top surface of said porous storage medium layer includes applying a mixture of said first base material and said resin on to said top surface of said porous storage medium layer prior to said resin being fully cured.

23. The method of claim 21, wherein said porous storage medium layer includes one or more remediating agents.

24. The method of claim 23, further including the step of inserting said one or more remediating agents into said porous storage medium layer after said permeable composite capstone layer has been applied to said top surface of said porous storage medium layer, said step of inserting said one or more remediating agents including preparing a liquid mixture of said one or more remediating agents, and pour said mixture onto said top surface of said permeable composite capstone layer to cause said liquid mixture to flow through said permeable composite capstone layer and to be deposited in said porous storage medium layer.

25. The method of claim 21, wherein said first base material includes one or more materials selected from the group consisting of limestone, shale, slate, sandstone, quartz, feldspar, dolomite, obsidian, mica, diorite, flint, granite, glass, rubber, recycled concrete, recycled asphalt, expanded shale, expanded slate, and recycled plastic.

26. The method of claim 21, wherein said permeable composite capstone layer includes a second base material, said second base material is different from said first base material.

27. The method of claim 26, wherein said second base material includes one or more materials selected from the group consisting of limestone, shale, slate, sandstone, quartz, feldspar, dolomite, obsidian, mica, diorite, flint, granite, glass, rubber, recycled concrete, recycled asphalt, expanded shale, expanded slate, and recycled plastic.

28. The method of claim 21, wherein said resin includes one or more materials selected from the group consisting of epoxy, urethane, acrylic, styrene, butadiene, and silicone.

29. The method of claim 21, wherein said first storage medium layer component includes one or more materials selected from the group consisting of shale, slate, expanded shale, expanded slate, and other synthetic material.

30. The method of claim 23, wherein said remediating agents includes one or more microbes selected from the group consisting of Micrococcus, Arthrobacter, Rhodococcus, Pantoea aggiomerans, Microbacterium laevaniformans, Pseudomonas putida, Achromobacter, Aspergillys, Bacillus, Candida, Cladosporium, Corynebacterium, Myrothecium, Punicillium, Phialophora, Phodothorula, Streptomyces, and Trichoderma.

31. The method of claim 23, wherein said one or more remediating agents are 0.1 vol. % to 40 vol. % of said porous storage medium layer.

32. The method of claim 23, wherein said remediating agents includes one or more remediating agents selected from the group consisting of chemical remediating agent, physical remediating agent and biological remediating agent.
